(19) United States
(12) Patent Application Publication
(10) Pub. No.: US 2010/0105824 A1
(43) Pub. Date: Apr. 29, 2010

(54) Polymer Compositions

(75) Inventors: Michael Greene, Santa Barbara, CA (US); Roger Norman Rothon, Guilden Sutton (GB); Nigel Julian Keith Danvers, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: WORLD MINERALS, INC., SANTA BARBARA, CA (US)

(21) Appl. No.: 12/513,365

(22) PCT Filed: Nov. 2, 2007
(86) PCT No.: PCT/GB2007/004203

§ 371 Date: Jul. 31, 2009

Related U.S. Application Data
(60) Provisional application No. 60/864,264, filed on Nov. 3, 2006.

(51) Int. Cl. C08K 3/40

(52) U.S. Cl. 524/494

(57) ABSTRACT

A polymer composition comprising greater than about 30% by weight of a perlite based on the total weight of the polymer composition, wherein said perlite has an oil absorption less than about 100%

The present invention relates to polymer compositions comprising perlite, to processes of production thereof, to articles formed from the polymer compositions, and to uses of the polymer compositions.

### BACKGROUND OF THE INVENTION

It is well known to incorporate particulate inorganic materials, such as ground inorganic minerals, into polymer compositions for a variety of purposes. One widespread use of such particulate materials is as a reinforcing or functional filler for a polymer composition.

It is known to use conventional expanded perlite in polymer systems. However, conventional expanded perlite can only be added at relatively low loading levels in polymer systems due to its high oil absorption, which is typically 200-400% or even greater.

U.S. Pat. No. 5,344,866 describes reinforced polymer composites having a thermoplastic matrix material, reinforcing glass fibres and a heat expandable material such as unexpanded vermiculite or unexpanded perlite.

The present inventors have surprisingly found that perlite, and in particular perlite ore and milled expanded perlite, can be used as fillers in polymer compositions at relatively high loadings.

### SUMMARY OF THE INVENTION

According to a first aspect of the present invention, there is provided a polymer composition comprising greater than about 30% by weight of a perlite based on the total weight of the polymer composition, wherein the perlite has an oil absorption of less than about 100%.

The perlite of the invention may be perlite ore, or milled expanded perlite.

According to a second aspect of the present invention, there is provided a process for preparation of a polymer composition, said process comprising combining a perlite having an oil absorption less than about 100% in an amount of greater than about 30% by weight with a polymer, based on the total weight of the polymer composition.

According to a further aspect of the present invention, an article formed from the polymer composition according to the first aspect of the present invention is provided.

According to a further aspect of the present invention, the use of a perlite having an oil absorption less than about 100% as a filler in a polymer composition in an amount of greater than about 30% by weight, based on the total weight of the polymer composition is provided.

An advantage in employing perlite as a filler in polymer compositions in relatively high loadings (i.e. greater than about 30 wt %) is that smaller amounts of the polymer component are required, whilst preserving, or even improving upon, the general physical, mechanical and chemical properties of the filler polymer composition. The polymer components of filler polymer compositions are relatively expensive compared to the filler components, and thus, by employing greater amounts of filler, significant cost savings can be achieved.

### DETAILED DESCRIPTION OF THE INVENTION

As stated above, the present invention relates to a filler polymer composition comprising greater than about 30% by weight of a perlite, wherein the perlite has an oil absorption less than about 100%.

The perlite employed in the present invention is derived from perlite ore, which belongs to the class of natural glasses, commonly referred to as volcanic glasses, which are formed by the rapid cooling of siliceous magma and lava.

Perlite ore is a hydrated natural glass containing typically about 72-75% SiO₂, 12-14% Al₂O₃, 0.5-2% Fe₂O₃, 3-5% Na₂O, 4-5% K₂O, 0.4-1.5% CaO (by weight) and small concentrations of MgO, TiO₂ and other metallic elements. Perlite ore is distinguished from other natural glasses by a higher content (2-10% by weight) of chemically bonded water, the presence of a vitreous, pearly luster, and characteristic concentric or arcuate onion skin-like (i.e., perlitic) fractures.

The perlite employed in the polymer composition according to the present invention has an oil absorption of less than about 100%. In embodiments of the invention, the oil absorption may be less than about 80%, less than about 60%, less than about 40%, or less than about 30%. The oil absorption of the perlite may, for example, be between about 40 and about 70%. The oil absorption is measured in accordance with a modified ASTM D281. The details of modified ASTM D281 are set out in the following paragraph. The type of linseed oil is chosen according to ASTM D284 and the acid number is 3 plus or minus 1.

Exactly 1 gram, or any multiple thereof, of thoroughly mixed and air dried test material is weighed and placed upon a glass plate or marble slab. A dropping bottle containing raw linseed oil along with a pipette and rubber bulb is weighed to 0.1 gram. The linseed oil is added gradually, drop by drop (by means of the pipette), to the test material, typically at a rate of 1 drop of oil per second. During addition of oil, the mixture is stirred so that each drop of oil falls on a dry position of the sample. After the addition of each drop, the oil is thoroughly incorporated by rubbing up with a spatula. That is to say, the flat blade of the spatula is forced upon the perlite/oil mix and the mass is smeared across the glass plate. The test is complete when exactly enough oil has been incorporated with the test material to produce a very stiff, putty-like paste, that does not break or separate. The bottle and oil are then weighed to 0.1 gram and the weight of oil used is determined by difference. In this respect, the oil absorption of a material is typically reported as a percentage which corresponds to the amount of oil (in grams) absorbed by 100 grams of the material, taking into consideration the specific gravity of the oil used.

The polymer composition may comprise perlite in an amount of at least about 40% by weight, at least about 50% by weight, at least about 60% by weight, at least about 70% by weight, or at least about 80% by weight, based on the total weight of the polymer composition. The polymer composition may comprise perlite in an amount of from about 50% to 80% by weight, based on the total weight of the polymer composition.

The perlite employed in the polymer composition according to the present invention may be perlite ore, milled expanded perlite, or mixtures thereof.

In embodiments of the invention in which the perlite is perlite ore, the value of d₅₀ for the perlite ore may be less than about 500 μm, less than about 250 μm, less than about 100 μm, less than about 80 μm, less than about 60 μm, less than about 40 μm, or less than about 20 μm. The value of d₅₀ may be as low as 5 μm, as low as 2 μm or even as low as 1 μm.

In embodiments of the invention in which milled expanded perlite is employed in the polymer composition, the value of d₅₀ of the milled expanded perlite may be less than about 20 μm, less than about 15 μm, less than about 10 μm, less than about 8 μm, or less than about 6 μm. The value of d₅₀ may be as low as 1 μm, or even as low as 0.5 μm.

All particle size values pertaining to the particulate perlite are specified as equivalent spherical diameters, and are determined by laser light particle size analysis using a Leeds and Northrup Microtrac X100 (LNM X100) available from Leeds and Northrup, North Wales, Pa., USA. In this technique, the size of particles in powders, suspensions and emulsions may be measured using the diffraction of a laser beam, based on application of either Fraunhofer or Mie theory. In the present invention, Mie theory is applied. The term “mean particle size” or “d₅₀” used herein is the value, determined in this way, of the particle diameter at which there are 50% by volume of the particles which have a diameter less than the d₅₀ value. The term d_{π}is the particle size value less than which there are 90% by volume of the particles which have a diameter less than the d₉₀ value. The preferred sample formulation for measurement of particle sizes is a suspension in a liquid. The LNM X100 instrument normally provides particle size data to two decimal places, to be rounded up or down when determining whether the requirements of the present invention are fulfilled, or by other methods which give essentially the same result.

The finding that milled expanded perlite and perlite ore can be used in polymer compositions at relatively high loading levels (i.e. greater than about 30% by weight) is unexpected.

Conventional expanded perlite can only be added to polymer compositions at relatively low loading levels due to its high oil absorption (typically 200-400% or greater). It is believed that much of the oil absorption of conventional expanded perlite is attributable to its complex cell structure. The present inventors have surprisingly found that by milling the expanded perlite to a much smaller particle size it can be used as a filler in polymer compositions at much higher loading levels. Whilst not wishing to be bound by theory, it is believed that during milling of the expanded perlite material, the complex cell structure (in which a cell is essentially a void space partially or entirely surrounded by walls of glass) is destroyed, or at least partially destroyed, and the material takes on a more plate like nature, which also results in a much lower oil absorption.

Process conditions for preparing expanded perlite are disclosed in US Patent Application Publication No. 2006/0075930, the entire contents of which are hereby incorporated by reference. Generally, the expanded perlite employed in the compositions of the present invention can be prepared by methods which include milling (crushing and grinding), screening and thermal expansion. For example, perlite ore is crushed, ground and separated to a predetermined particle size range. The separate material can then be heated in air, typically at a temperature of 870-1100° C. in an expansion surface. The expanded perlite can be separated to meet particle size requirements.

Alternatively, perlite ore may be used as filler in the polymer compositions of the present invention. Perlite ore lacks the complex cell structure of expanded perlite and is essentially a ground natural glass having an inherently high water content. Perlite ore has also been found to have an oil absorption sufficiently low to permit its use as a filler in the polymer compositions of the present invention in relatively high loadings. Without wishing to be bound by theory, it is believed the low oil absorption seen in perlite ore is attributable to its lack of complex cell structure. The perlite ore may, for example, be Harborlite™ 574A, a perlite ore originating from Turkey. Harborlite™ 574A having a d₅₀ of 252 μm has been found to have an oil absorption of about 28%.

The perlite ore can be prepared using conventional crushing, grinding, milling and separating techniques.

In embodiments of the present invention, the perlite particles are surface treated to modify one or more properties of the perlite.

The surface of the perlite particles may be surface modified by a silanization agent. The surface of the perlite particles may be surface modified by a silanization agent in order to increase the hydrophobic or hydrophilic properties of the particles of perlite.

Silanization agents which are suitable for increasing the hydrophobic properties of the perlite particles may be selected from one or more of dimethyldichlorosilane, hexadimethylsilazane, butyltrichlorosilane, hexyltrichlorosilane, octyltrichlorosilane, octylmethyldichlorosilane, decyltrichiorosilane, dodecyltrichlorosilane, tridecyltrichiorosilane, dihexyldichlorosilane, dioctyldichlorosilane, octadecyltrichlorosilane, tributylchlorosilane, octyltrialkoxysilanes such as, for example, octyltriethoxysilane and octyltrimethoxysilane, chloropropyltrialkoxysilanes such as, for example, chloropropyltrimethoxysilane and chloropropyltriethoxysilane, polydimethylsiloxane, 3-methacryloxypropyltriethoxysilane, vinyl trialkoxysilanes such as, for example, vinyl trimethoxy silane, vinyl triethoxy silane and vinyl triisopropoxy silane, and mixtures thereof.

Silanization agents which are suitable for increasing the hydrophilic properties of the perlite particles may be selected from one or more of trimethoxysilyl ethyl amine, triethoxysilyl ethyl amine, tripropoxysilyl ethyl amine, tributoxysilyl ethyl amine, trimethoxysilyl propyl amine, triethoxysilyl propyl amine, tripropoxysilyl propyl amine, triisopropoxysilyl propyl amine, tributoxysilyl propyl amine, trimethoxysilyl butyl amine, triethoxysilyl butyl amine, tripropoxysilyl butyl amine, tributoxysilyl butyl amine, trimethoxysilyl pentyl amine, triethoxysilyl pentyl amine, tripropoxysilyl pentyl amine, tributoxysilyl pentyl amine, trimethoxysilyl hexyl amine, triethoxysilyl hexyl amine, tripropoxysilyl hexyl amine, tributoxysilyl hexyl amine, trimethoxysilyl heptyl amine, triethoxysilyl heptyl amine, tripropoxysilyl heptyl amine, tributoxysilyl heptyl amine, trimethoxysilyl octyl amine, triethoxysilyl octyl amine, tripropoxysilyl octyl amine, tributoxysilyl octyl amine, triethanolamine (TEA), 2-amino-2-methyl-1-propanol, AMP-95™ (2-amino-2-methyl-1-propanol formulation containing 5% water), and mixtures thereof.

As will be readily understood by the skilled person, the polymer compositions may be compounded with other components or additives, such as for example titanium dioxide, carbon black, iron oxides, zinc oxide, alumina trihydrate, calcium sulphate, zinc borate, zinc sulfate, magnesium hydroxide, mica, vermiculite, quart, talc, wollastonite, diatomaceous earth, pumice, synthetic silica, silica gels, synthetic aluminosilicates, barium sulphate, calcium carbonate, clay, exfoliated clays, antioxidants, stabilizers, lubricants, and mixtures thereof.

### Polymers

The polymer to be filled in accordance with the present invention comprises any natural or synthetic polymer or mixture thereof. The polymer may, for example, be thermoplastic or thermoset. The term “polymer” used herein includes homopolymers and/or copolymers, as well as crosslinked and/or entangled polymers.

The term “precursor” as applied to the polymer component will be readily understood by one of ordinary skill in the art. For example, suitable precursors may include one or more of: monomers, cross-linking agents, curing systems comprising cross-linking agents and promoters, or any combination thereof. Where, according to the present invention, the perlite material is mixed with precursors of the polymer, the polymer composition will subsequently be formed by curing and/or polymerising the precursor components to form the desired polymer.

Polymers, including homopolymers and/or copolymers, comprised in the polymer composition of the present invention may be prepared from one or more of the following monomers: acrylic acid, methacrylic acid, methyl methacrylate, and alkyl acrylates having 1-18 carbon atoms in the alkyl group, styrene, substituted styrenes, divinyl benzene, diallyl phthalate, butadiene, vinyl acetate, acrylonitrile, methacrylonitrile, maleic anhydride, esters of maleic acid or fumaric acid, tetrahydrophthalic acid or anhydride, itaconic acid or anhydride, and esters of itaconic acid, with or without a cross-linking dimer, trimer, or tetramer, crotonic acid, neopentyl glycol, propylene glycol, butanediols, ethylene glycol, diethylene glycol, dipropylene glycol, glycerol, cyclohexanedimethanol, 1,6 hexanediol, trimethyolpropane, pentaerythritol, phthalic anhydride, isophthalic acid, terephthalic acid, hexahydrophthalic anyhydride, adipic acid or succinic acids, azelaic acid and dimer fatty acids, toluene diisocyanate and diphenyl methane diisocyanate. Copolymers comprising methyl methacrylate and styrene monomers are preferred.

The polymer may be selected from one or more of polymethylmethacrylate (PMMA), polyacetal, polycarbonate, polyacrylonitrile, polybutadiene, polystyrene, polyacrylate, polypropylene, epoxy polymers, unsaturated polyesters, polyurethanes, polycyclopentadienes and copolymers thereof. Suitable polymers also include liquid rubbers, such as silicones.

### Preparation of the Polymer Composition

The polymer composition of the present invention is prepared by combining a perlite having an oil absorption less than about 100% and in an amount of at least about 30% by weight with a polymer, based on the total weight of the polymer composition.

Preparation of the polymer compositions of the present invention can be accomplished by any suitable mixing method known in the art, as will be readily apparent to one of ordinary skill in the art.

Such methods include dry blending of the individual components or precursors thereof and subsequent processing in a conventional manner. Certain of the ingredients can, if desired, be pre-mixed before addition to the compounding mixture.

In the case of thermoplastic polymer compositions, such processing may comprise melt mixing, either directly in an extruder for making an article from the composition, or pre-mixing in a separate mixing apparatus. Dry blends of the individual components can alternatively be directly injection moulded without pre-melt mixing.

The polymer composition can be prepared by mixing of the components thereof intimately together. The said perlite material may then be suitably dry blended with the polymer and any desired additional components, before processing as described above.

For the preparation of cross-linked or cured polymer compositions, the blend of uncured components or their precursors, and, if desired, the perlite and any desired non-perlite component(s), will be contacted under suitable conditions of heat, pressure and/or light with an effective amount of any suitable cross-linking agent or curing system, according to the nature and amount of the polymer used, in order to cross-link and/or cure the polymer.

For the preparation of polymer compositions where the perlite and any desired other component(s) are present in situ at the time of polymerisation, the blend of monomer(s) and any desired other polymer precursors, perlite and any other component(s) will be contacted under suitable conditions of heat, pressure and/or light, according to the nature and amount of the monomer(s) used, in order to polymerise the monomer(s) with the perlite and any other component(s) in situ.

In one embodiment, the perlite is dispersed with agitation into a mixture comprising polymer (for example, polymethylmethacrylate) and a curing agent. The mixture may further comprise a mould release agent.

The resulting dispersion can be degassed to remove entrained air. The resulting dispersion can then be poured into a suitable mould and cured. Suitable curing temperatures range from 20-200° C., for example 20-120° C., or, for example, 60-90° C.

The starting polymer mixture can further comprise a pre-polymer (for example, methylmethacrylate monomer). The pre-polymer may or may not correspond to the starting polymer.

The viscosity of the starting polymer or polymer/monomer solution, amount of curing agent, release agent and perlite can be varied according to the requirements of the final cured product. Generally, the greater the amount of perlite added, the higher the viscosity of the dispersion. Dispersant agents can be added to reduce the viscosity of the dispersion. Alternatively, the amount of polymer in the starting solution can be reduced.

Suitable curing agents will be readily apparent to one of ordinary skill in the art, and include organic peroxides, hydroperoxides and azo compounds. Examples of peroxide and hydroperoxide curing agents include dimethyl dibutylperoxyhexane, benzyl peroxide, dicumyl peroxide, methyl ethyl ketone peroxide, lauryl peroxide, cyclohexanone peroxide, t-butyl perbenzoate, t-butyl hydroperoxide, t-butyl benzene hydroperoxide, cumene hydroperoxide and t-butyl peroctoate. One preferred curing agent is Perkadox™ 16 (commercially available from Akzo Nobel).

Suitable mould release agents will be readily apparent to one of ordinary skill in the art, and include fatty acids, and zinc, calcium, magnesium and lithium salts of fatty acids and organic phosphate esters. Specific examples are stearic acid, zinc stearate, calcium stearate, magnesium stearate, lithium stearate calcium oleate, zinc palmitate.

In another embodiment, the process includes the step of mixing or blending a perlite in an amount of greater than about 30% by weight with a pre-formed polymer. For example, the perlite may be added to a twin-screw extruder to which unfilled polymer is being fed and made molten. The perlite is fed into the extruder through a hopper and uniformly blends with the polymer. The mixture emerges from the extruder and may be cooled. Then, for example, the mixture can be further compression moulded or injection moulded into useful shapes.

### Uses of the Polymer Compositions

The polymer compositions can be processed to form, or to be incorporated in, articles of commerce in any suitable way. Such processing may include compression moulding, injection moulding, gas-assisted injection moulding, calendaring, vacuum forming, thermoforming, extrusion, blow moulding, drawing, spinning, film forming, laminating or any combination thereof. Any suitable apparatus may be used, as will be apparent to one of ordinary skill in the art.

The articles which may be formed from the compositions are many and various. Examples include solid surface countertop materials, gears and bushings.

Polymethylmethacrylate (PMMA) and like polymers are typically used in solid surface countertop materials, for example, Corian™ and Silestone™. Typically, these solid surface materials are highly filled with ground quartz, alumina tri-hydrate (ATH), or a mixture of the two. The ground quartz is added for its hardness and durability, while ATH is typically added for its flame retardant properties. However, ground quartz suffers from the potential health issues related to its crystalline silica content. Thus, milled expanded perlite and perlite ore may be desirable quartz replacements in these applications due to their hardness and lack of crystalline silica.

In addition, upon heating perlite ore, the water can be released which may provide a degree of fire retardancy. Thus, in embodiments in which the perlite ore is used in conjunction with resin systems such as PMMA, the perlite ore may be suitable as a replacement for at least a portion of ATH (as well as a quartz replacement).

Other polymers which are particularly useful in worktops, including sinks, include epoxies, unsaturated polyesters and polyurethanes.

The invention will now be illustrated, by reference to the following non-limiting examples.

### EXAMPLES

### Example 1

100g of a solution (known as a ‘syrup’) of polymethylmethacrylate (PMMA) in monomer methyl methacrylate (MMA) was prepared having a viscosity at 20° C. of 240 cps. To the syrup was added 1.25 g of a peroxide catalyst (Perkadox 16 commercially available from Akzo Nobel) and 0.4 g of a mould release agent (stearic acid). 150 g of Harborlite™ 574A, a graded perlite ore, was then dispersed into the syrup with gentle agitation. The resulting composition was then degassed to remove entrained air.

The degassed dispersion was then made into sheets as follows. The dispersion was poured slowly into a mould. In this example, the mould was made of two flat glass sheets, separated by a rubber gasket in place with clips (the glass plates were 70 mm×70 mm with a 5 mm space between). The mould containing the dispersion was then placed in a water bath at 60° C. for 30 minutes to pre-cure the dispersion, and finally into a hot air oven at 90° C. for a further 40 minutes. After cooling, the clips were released and the cured sheet of perlite filled PMMA product was removed.

1-76. (canceled)

77. A polymer composition comprising greater than about 30% by weight of a perlite based on the total weight of the polymer composition, wherein the perlite has d₅₀ of less than about 100 μm and an oil absorption less than about 100%.

78. The polymer composition according to claim 77, wherein the perlite has an oil absorption less than about 80%.

79. The polymer composition according to claim 77, wherein the perlite has an oil absorption less than about 60%.

80. The polymer composition according to claim 77, wherein the perlite has an oil absorption less than about 40%.

81. The polymer composition according to claim 77, wherein the perlite has an oil absorption ranging from about 40 % to about 70%.

82. The polymer composition according to claim 77, wherein the composition comprises at least about 40 % by weight of the perlite.

83. The polymer composition according to claim 77, wherein the composition comprises at least about 60 % by weight of the perlite.

84. The polymer composition according to claim 77, wherein said composition comprises at least about 80 % by weight of the perlite.

85. The polymer composition according to claim 77, wherein the perlite is a milled expanded perlite.

86. The polymer composition according to claim 77, wherein the perlite is a perlite ore.

87. The polymer composition according to claim 77, wherein the perlite is a milled expanded perlite having a d₅₀ of less than about 20 μm.

88. The polymer composition according to claim 77, wherein the perlite is a milled expanded perlite having a d₅₀ of greater than about 0.5 μm.

89. The polymer composition according to claim 77, wherein the polymer is a polymer or copolymer prepared from one or more monomers selected from the group consisting of acrylic acid, methacrylic acid, alkyl acrylates and methacrylates having 1-18 carbon atoms in the alkyl group, styrene, substituted styrenes, butadiene, vinyl acetate, acrylonitrile, methacrylonitrile, maleic anhydride, esters of maleic acid, itaconic acid and esters of itaconic acid, with or without a cross-linking dimer, trimer, or tetramer, crotonic acid, neopentyl glycol, cyclohexanedimethanol, 1,6 hexanediol, trimethylpropoane, pentaerythritol, phthalic anhydride, isophthalic acid, hexahydrophthalic anyhydride, adipic acid, azelaic acid, and dimer fatty acids.

90. The polymer composition according to claim 77, wherein the polymer is a polymethylmethacrylate.

91. The polymer composition according to claim 77, comprising one or more additional materials selected from the group consisting of titanium dioxide, carbon black, iron oxides, zinc oxide, alumina trihydrate, calcium sulphate, zinc borate, zinc sulfate, magnesium hydroxide, mica, vermiculite, quart, talc, wollastonite, diatomaceous earth, pumice, synthetic silica, silica gels, synthetic aluminosilicates, barium sulphate, calcium carbonate, clay, exfoliated clays, antioxidants, stabilizers, and lubricants.

92. The polymer composition according to claim 77, wherein the particles of the perlite are surface treated to modify one or more properties of the perlite.

93. The polymer composition according to claim 92, wherein the surface of the perlite particles are surface modified by a silanization agent.

94. The polymer composition according to claim 93, wherein the silanization agent is selected from the group consisting of dimethyldichlorosilane, hexadimethylsilazane, butyltrichlorosilane, hexyltrichlorosilane, octyltrichlorosilane, octylmethyldichlorosilane, decyltrichlorosilane, dodecyltrichlorosilane, tridecyltrichlorosilane, dihexyldichlorosilane, dioctyldichlorosilane, octadecyltrichlorosilane, tributylchlorosilane, octyltriethoxysilane, octyltrimethoxysilane, chloropropyltrimethoxysilane, chloropropyltriethoxysilane, polydimethylsiloxane, 3-methacryloxypropyltriethoxysilane, vinyl trimethoxy silane, vinyl triethoxy silane and vinyl triisopropoxy silane, and mixtures thereof.

95. The polymer composition according to claim 93, wherein the silanization agent is selected from the group consisting of trimethoxysilyl ethyl amine, triethoxysilyl ethyl amine, tripropoxysilyl ethyl amine, tributoxysilyl ethyl amine, trimethoxysilyl propyl amine, triethoxysilyl propyl amine, tripropoxysilyl propyl amine, triisopropoxysilyl propyl amine, tributoxysilyl propyl amine, trimethoxysilyl butyl amine, triethoxysilyl butyl amine, tripropoxysilyl butyl amine, tributoxysilyl butyl amine, trimethoxysilyl pentyl amine, triethoxysilyl pentyl amine, tripropoxysilyl pentyl amine, tributoxysilyl pentyl amine, trimethoxysilyl hexyl amine, triethoxysilyl hexyl amine, tripropoxysilyl hexyl amine, tributoxysilyl hexyl amine, trimethoxysilyl heptyl amine, triethoxysilyl heptyl amine, tripropoxysilyl heptyl amine, tributoxysilyl heptyl amine, trimethoxysilyl octyl amine, triethoxysilyl octyl amine, tripropoxysilyl octyl amine, tributoxysilyl octyl amine, triethanolamine (TEA), 2-amino-2-methyl-1-propanol, AMP-95TM (2-amino-2-methyl-1-propanol formulation containing 5% water), and mixtures thereof.

96. A solid surface countertop material comprising greater than about 30% by weight of a perlite based on the total weight of the polymer composition, wherein the perlite has d₅₀ of less than about 20 μm and an oil absorption less than about 100%.
